(19) United States
(12) Patent Application Publication
(10) Pub. No.: US 2013/0066733 A1
(43) Pub. Date: Mar. 14, 2013

(54) ELECTRONIC NEGOTIATION IN A REAL-WORLD ENVIRONMENT

(71) Applicants: Robert I. LEVY, Los Gatos, CA (US); Paul R. PATTERSON, Monte Sereno, CA (US)

(72) Inventors: Robert I. LEVY, Los Gatos, CA (US); Paul R. PATTERSON, Monte Sereno, CA (US)

(73) Assignee: PRICETECTOR, INC., Los Gatos, CA (US)

(21) Appl. No.: 13/230,578

(22) Filed: Sep. 12, 2011

(51) Int. Cl. G06Q 30/00

(52) U.S. Cl. 705/16; 705/26.1

(57) ABSTRACT

A system for enabling a retail transaction between a brick-and-mortar retailer and a customer, comprising: a mobile device including an application operated by the customer while physically present in the brick-and-mortar retailer, wherein the application is designed to obtain product information about a product and offer information from the customer including a proposed price for the product; a user information aggregation server designed to receive the product information and the offer information from the application on the mobile device and augment the product information and offer information with information about the customer, and to forward the product information, offer information, and customer information to a decision server; and further designed to receive a decision as to whether the offer has been accepted by the decision server, wherein the decision is at least partially based on the customer information, and to notify the customer.

### BACKGROUND OF THE INVENTION

1. Field of the Invention

The present invention relates generally to conducting electronic negotiations. More particularly, the present invention relates to a system and method for performing an electronic negotiation in a real world environment.

2. Description of the Related Art

Shopping in a brick-and-mortar retailer has been the most common way to purchase goods, until very recently. With the advent of the Internet, more and more consumers are electing to make their purchases online rather than in a real world store. Nevertheless, brick-and-mortar retailers still represent the most common way to purchase most goods, and there are advantages that cause customers to elect to purchase (or at least browse) in a real world store, most particularly the ability to see, feel, smell, try on, etc. the item in person. Other patrons simply do not have Internet access or do not wish to use the Internet to shop for various reasons. Yet other customers prefer to have a salesperson help out in the decision-making process.

Whatever the rationale for people wanting to visit a brick-and-mortar retailer, these stores are increasingly having a difficult time competing with online retailers. While part of that is based on the fact that price points for online purchases are typically lower (due to less overhead), part of it is also due to the ability to comparison shop between retailers quickly and easily when shopping online, outweighing the lack of real world experiences with the product that would ordinarily draw the consumer away from an online experience to the brick-and-mortar retailer.

While many brick-and-mortar retailers have also opened up online presences where products can also be purchased, these retailers still have a strong incentive to draw customers into a brick-and-mortar retailer. Most particularly, customers who visit the store in person are more likely to purchase other items as well as the item they came in for, giving the salesperson the ability to upsell the customer with additional accessories or even completely other products that he or she may not have purchased if the visit was purely virtual.

While common in some countries, negotiation in a brick-and-mortar retailer is rare in the United States. Most brick-and-mortar retailers post a set price. This price is typically non-negotiable, although sales are run occasionally and coupons accepted. To the extent that negotiations on price do occur, from the retailer perspective they tend to not differentiate one potential customer from another, and thus treat all customers the same as to negotiation (the individual salesperson, of course, may react differently to one person's negotiation style than another's, but from the retailer perspective, it really doesn't matter whether customer A purchases the good at the reduced rate or whether customer B purchases the good at the reduced rate).

Treating all customers as equally valuable actually turns out not to be an effective business practice. Certain customers are repeat customers, or may turn into repeat customers should they obtain a good enough deal. Other customers may simply take the good deal on the one item and never return to the store again. Therefore, a more efficient negotiation policy would be to be willing to provide a steeper discount to customers who are repeat customers, or who are likely to turn into repeat customers. Of course, there are other factors that may influence whether or not it would be a good idea for a retailer to offer a steeper discount to one customer over another. Perhaps a customer has participated in market research for the retailer, or visits partner retailers, or has viewed advertising in the store, etc. Regardless of the rationale behind the retailer's ultimate decision, it can be seen that the ability to negotiate different prices with different customers while having knowledge about information that would be helpful in determining whether one customer is more “valuable” to the retailer than another would be a very powerful tool in increasing overall sales and profits.

Currently, there exists no way for a retailer to make a decision via a negotiation while having this type of information at its disposal. As such, negotiations in brick-and-mortar retailers typically occur on an ad hoc basis with no rhyme or reason as to which customers get which deals.

Furthermore, the growth of the Internet has produced a number of electronic negotiation websites. They are, in fact, quite common in the travel industry. For example, Priceline.com offers the customers the ability to name a price for a hotel room or airline ticket. The customer enters a price he or she wishes to pay as well as criteria information regarding the trip (hotel class, dates, non-stop only flights, etc.) and the system then electronically passes the bid and criteria to a number of partners who may either accept or reject the bid. Despite the electronic nature of the transaction, however, the partners in this scenario do not utilize user information to give one user a different deal than another user. The rooms and flights are viewed as a commodity, and any user bidding a price that the partner finds acceptable will receive a confirmation that the offer has been accepted, whether or not this user would be considered to be a valuable customer.

As such, what is needed is a solution that addresses these issues.

### SUMMARY OF THE INVENTION

In a first embodiment of the present invention, a system for enabling a retail transaction between a brick-and-mortar retailer and a customer is provided, the system comprising: a mobile device, wherein the mobile device includes an application operated by the customer while physically present in the brick-and-mortar retailer, wherein the application is designed to obtain product information about a product and offer information from the customer including a proposed price for the product; a user information aggregation server designed to receive the product information and the offer information from the application on the mobile device and augment the product information and offer information with information about the customer, and to forward the product information, offer information, and customer information to a decision server; and wherein the user information aggregation server is further designed to receive a decision as to whether the offer has been accepted by the decision server, wherein the decision is at least partially based on the customer information, and to notify the customer of the decision.

In a second embodiment of the present invention, a method for enabling a retail transaction between a brick-and-mortar retailer and a customer is provided, the method comprising: receiving a product identification and an offer price from a mobile device operated by the customer while located at the brick-and-mortar retailer; determining information about the customer; sending the product information and the offer price to a decision server along with the information about the customer; receiving an indication from the decision server as to whether or not the offer has been accepted, wherein the decision server bases the decision at least partially on the information about the customer; and sending the indication to the mobile device for display to the customer.

In a third embodiment of the present invention, a non-transitory program storage device readable by a machine tangibly embodying a program of instructions executable by the machine to perform a method for enabling a retail transaction between a brick-and-mortar retailer and a customer is provided, the method comprising: receiving a product identification and an offer price from a mobile device operated by the customer while located at the brick-and-mortar retailer; determining information about the customer; making a determination of whether to accept the offer based on rules provided by a retailer server, wherein the determination is based on a combination of the information about the customer, the product information, and the offer price; and sending an indication about the determination to the customer and to the brick-and-mortar retailer.

In a fourth embodiment of the present invention, an apparatus for enabling a retail transaction between a brick-and-mortar retailer and a customer is provided, the apparatus comprising: means for receiving a product identification and an offer price from a mobile device operated by the customer while located at the brick-and-mortar retailer; means for determining information about the customer; means for sending the product information and the offer price to a decision server along with the information about the customer; means for receiving an indication from the decision server as to whether or not the offer has been accepted, wherein the decision server bases the decision at least partially on the information about the customer; and means for sending the indication to the mobile device for display to the customer.

### BRIEF DESCRIPTION OF THE DRAWINGS

FIG. 1 is a diagram illustrating a system for electronic negotiation in a brick-and-mortar retailer in accordance with an embodiment of the present invention.

FIG. 2 is a diagram illustrating a point-of-sale system that may be utilized with an embodiment of the present invention.

FIG. 3 is a diagram illustrating a system for electronic negotiation in a brick-and-mortar retailer in accordance with another embodiment of the present invention.

FIG. 4 is a diagram illustrating a system for electronic negotiation in a brick-and-mortar retailer in accordance with another embodiment of the present invention.

FIG. 5 is a diagram illustrating a system for electronic negotiation in a brick-and-mortar retailer in accordance with another embodiment of the present invention.

FIG. 6 is a flow diagram illustrating a method for enabling a retail transaction between a brick-and-mortar retailer and a customer in accordance with an embodiment of the present invention.

FIG. 7 is a flow diagram illustrating a method for enabling a retail transaction between a brick-and-mortar retailer and a customer in accordance with another embodiment of the present invention.

FIG. 8 is a screen capture depicting a registration screen in accordance with an embodiment of the present invention.

FIG. 9 is a screen capture depicting a main menu screen in accordance with an embodiment of the present invention.

FIG. 10 is a screen capture depicting a pick my price screen in accordance with an embodiment of the present invention.

FIG. 11 is a screen capture depicting a selection of retailer screen in a pick my price module in accordance with an embodiment of the present invention.

FIG. 12 is a screen capture depicting the scanning of a barcode in accordance with an embodiment of the present invention.

FIG. 13 is a screen capture depicting the entering of an offer in accordance with an embodiment of the present invention.

FIG. 14 is a screen capture depicting an entered offer in accordance with an embodiment of the present invention.

FIG. 15 is a screen capture depicting confirmation of a received offer in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, a system is provided that allows a user to conduct an electronic negotiation with a retailer while the user is physically present in a brick-and-mortar retailer. In one example, a user may scan or otherwise enter information about a product he or she is viewing in person into a smartphone. The user may then specify a particular price to pay for the product. This information, along with information about the user, is transmitted to a user information aggregation server. The user information aggregation server can then augment this information with additional information about the user and pass all of this to a server controlled by the retailer. The retailer may then decide whether or not to accept, refuse, or counter the offer from the user based at least partially about the information about the user. This allows the retailer to make decisions as to which users to be more “lenient” towards during negotiations based on the value of the individual user.

It should be noted that the term “brick-and-mortar retailer” shall be construed to mean any business having a physical presence at which a customer may visit in order to purchase an item. In that respect, a “brick-and-mortar retailer” can be differentiated from an “online retailer” where the customer visits only a virtual store via the Internet or other data network. However, one of ordinary skill in the art recognizes that many “brick-and-mortar” retailers also operate as “online retailers” and vice-versa. As such, for purposes of this document, in cases wherein a retailer has both a brick-and-mortar physical presence and an online presence, the “brick-and-mortar retailer” shall be construed to mean the brick-and-mortar presence of the retailer.

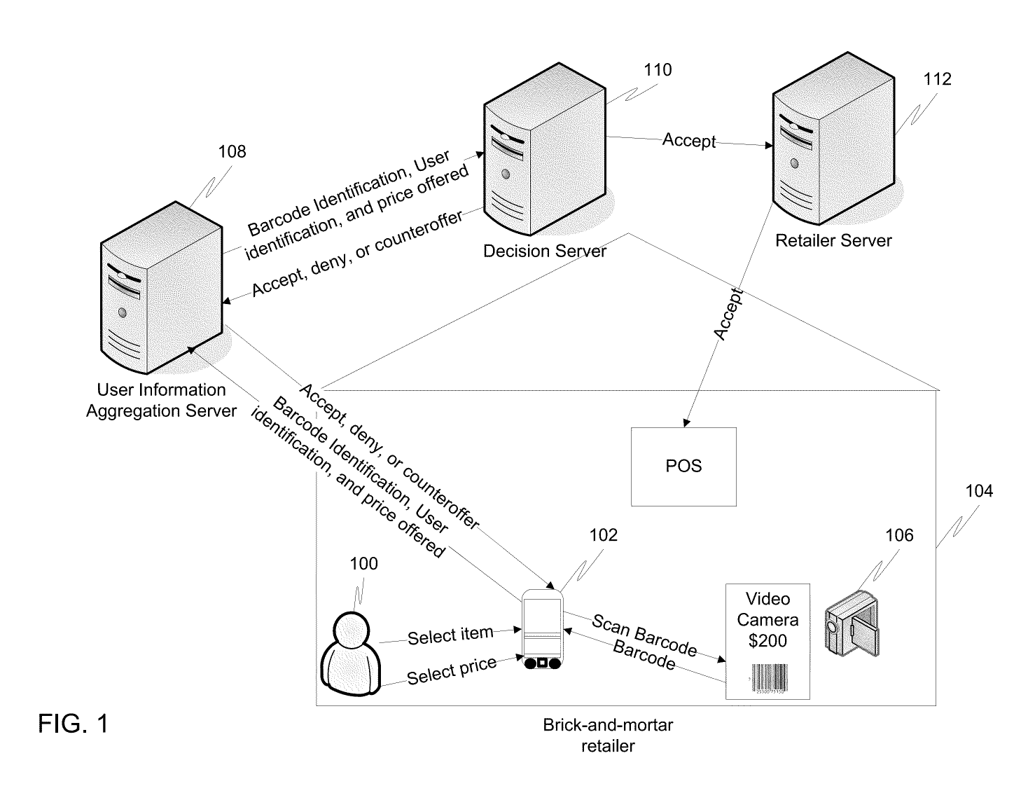

FIG. 1 is a diagram illustrating a system for electronic negotiation in a brick-and-mortar retailer in accordance with an embodiment of the present invention. Here, user 100 operates a smartphone 102 while in brick-and-mortar retailer 104. Specifically, the user is viewing product 106 and enters information about the product in the smartphone to identify the product. This may involve scanning a barcode or QR code using a scanning program and camera built into the smartphone. Alternatively, the user could enter the product information using keypad input. It should be noted that while a smartphone is depicted in FIG. 1, this embodiment of the present invention could be implemented using any mobile device.

Other embodiments describing different ways to input the product identification are also foreseen. For example, the user may take an actual picture of the physical tag affixed to the product. This can be used in lieu of a barcode or QR scan, or may alternatively be used to augment the barcode or QR scan as barcode and QR scans are not always completely reliable. In another embodiment, the user may take a picture of the actual product itself, and image recognition software, either located on the smartphone itself or on an outside server, can determine a product identification based on the picture.

Once the product is identified, the user 100 enters a price he or she wishes to pay into smartphone 102. Smartphone 102 then transmits information about the user (such as a user identification), the product information, and the price to a user information aggregation server 108. The user information aggregation server 108 maintains information about users that may be useful in determining whether the user is “valuable” to the retailer. Such information can include information on past purchases (e.g., how much the user spends and how often), demographic information, such as gender, age, residence city, and user interest information, such as information the user has provided regarding likes and dislikes. Information on past purchases can be gathered by tracking previous purchases made via the system of this embodiment of the invention and/or by interfacing with financial services companies (such as credit card companies and banks) and retailers themselves. Demographic information may be gathered via registration, wherein the user, in order to utilize the system of this embodiment of the present invention, would have previously registered with user information aggregation server 108 and may be asked for such information during the registration process. User interest information could also be provided during the registration process, or may be uploaded from a user profile stored on smartphone 102 at or before the time the offer to purchase is made. As to user interests, a user who, for example, is a runner may purchase a lot of shoes in a given year, whereas a user who is not a runner may only purchase one shoe a year.

Because the user information aggregation server 108 has at its disposal this additional user information, it augments the product identification and offer information with the user information prior to it being sent to the decision server 110 for processing. Decision server 110 then takes not only the product identification and bid information into account when making its decision as to whether to accept, deny, or counter the offer from user 100, but also takes into account the user information about the user 100, essentially making the decision customized for the user him or herself.

The decision server 110 may implement various rules to automatically make the decision as to accept, deny, or counter the offer at the time the offer is made. This allows the decision server 110 to answer the user immediately, while the user is still in the store and can simply purchase the item. Alternatively, the decision server 110 may delay the decision until more information is received. For example, the retailer may be willing to drop the price of an item by $10, but only if 100 different customers are willing to purchase at the new discounted price. As such, it can save the offers to purchase at that discounted price until 100 customers offers at that price are received, and then accept all of them. They could either request that the user come back to the store to complete the purchase, or may complete the purchase via an online version of the store.

It should be noted that FIG. 1 depicts a decision server making the decision as to whether to accept, reject, or counter the offer. This decision server may actually be operated by the entity that operates the user information aggregation server, or alternatively may be operated by the retailer. In either instance, the decision server may not actually be a separate physical server but rather may simply be integrated within whatever functionality the entity runs. For example, if the decision server is operated by the retailer, it may actually be integrated into the retailer server. If the decision server is operated by the entity that operates the user information aggregation server, it may actually be integrated into the user information aggregation server. In FIG. 1, it is depicted as a separate sever from either.

Communication of offers from the user information aggregation server to the retailer server can occur either in a streaming fashion (i.e., as offers are received) or can be performed as a periodic batch to the retailer server for disposition. The communication can be performed over any type of computer network and in any format.

The retailer's decision as to whether or not to accept particular offers can be enabled through the use of a hosted dashboard analytics and management system that allows the retailer to analyze consumer offer behavior in general and set governing policy rules to keep offer processing within rational business bounds. These rules may then be stored and implemented by the retailer server. The user information aggregation server may provide this dashboard to the retailer server. In another embodiment of the present invention, the user information aggregation server goes even further, providing the retailer server with the ability to submit deep analytical queries and return realtime or periodic statistics to the retailer server in a form that the retailer server can analyze and act on, using APIs to exert control over offer processing policies.

The form of the individual rules may vary greatly based on implementation. In one embodiment, a certain variance from the original price of the product may be permitted to be automatically executed via rules, whereas an amount that exceeds that variance would be required to be specifically approved by the retailer. For example, the retailer could indicate that up to a 10% price drop can be automatically granted based on the value of the user, but anything more than that must require preauthorization before granting of the price drop.

While in the above embodiment the decision server 110 makes the decision as to the value of the user based on the raw data, embodiments are foreseen wherein the user information aggregation server 108 provides some level of analysis to the decision server 112 as to the value of the user. For example, the user information aggregation server 108 may provide a “grade’ for the user, indicating a relative value of the user to retailers in general. This grade may be based on several factors, including the number of items purchased, the value of items purchased, how many people the user tells about the item, retailers, or user information aggregation server, whether the user is a blogger, demographic information, and user interests, for example.

How the decision as to whether to accept, deny, or counter the offer is communicated can vary greatly based on implementation. In one embodiment, the user is alerted of the decision by the decision server 110 passing the decision to the aggregation server 108, which then passes the decision to the smartphone 102. The brick-and-mortar retailer 104 may also be alerted of the decision via retailer server 112, although in the embodiment depicted in FIG. 1 they are only alerted if an offer is accepted. This is because the brick-and-mortar retailer 104 need only be aware of the decision if the offer is accepted, so that the appropriate price can be provided to the customer at checkout. As such, the decision by the retailer server can be passed directly to a point-of-sale (POS) system in the brick-and-mortar retailer. A user identification may be passed along with the information about the offer so that the cashier can apply the discount for the correct customer, and only for the correct customer.

The point-of-sale system may be any system that facilitates a transaction between the retailer and the customer. This may include an electronic point-of-sale system, or it may include some level of human involvement. For example, the indication of the decision about the offer can be sent to a store manager or clerk via a mobile device carried by the store manager or clerk, and then the store manager or clerk may then alter the sale price for the customer upon check out. However, given the amount of automation in retail transactions, it may be more preferable to integrate the present invention with an electronic point-of-sale system to allow the discounted price to be applied automatically, improving speed and reliability.

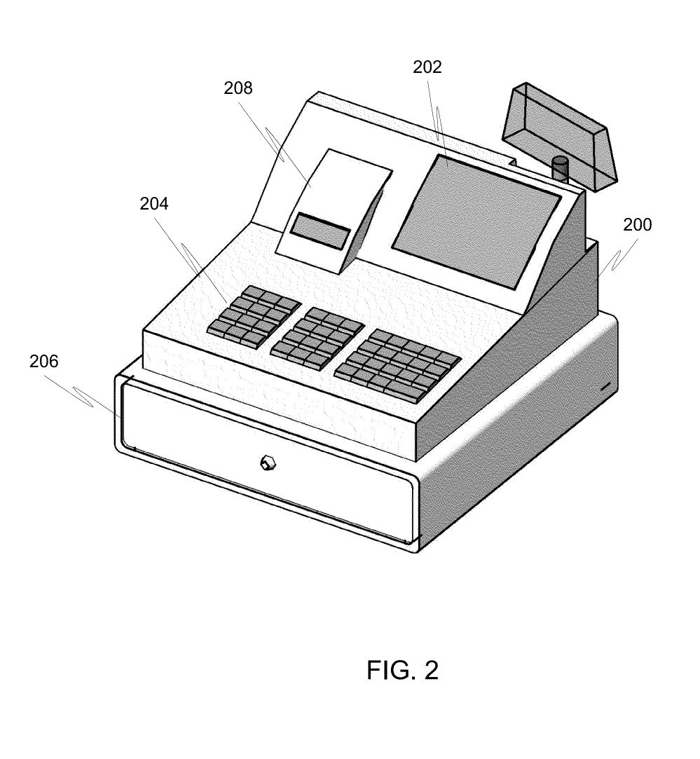

FIG. 2 is a diagram illustrating a point-of-sale system that may be utilized with an embodiment of the present invention. The front-end portion of the POS system comprises a computerized cash register 200 or similar computer system, including a display 202, and one or more input devices such as a keyboard 204 and barcode scanner (not pictured). The front-end POS system also includes a cash drawer component 206, much like a traditional cash register. The cash drawer component can be opened by the front-end POS application program running on the computer. The front-end POS system can further include a receipt printing device 208 that can print out a sale receipt at the end of the transaction. The front-end POS system can be used at each check-out line in at the brick-and-mortar retailer.

The front-end POS system essentially performs the same tasks as a traditional cash register machine, except it is electronic and may be networked to a centralized inventory/product database. A sales clerk can scan items to be purchased using the barcode scanner, or input product information via an input device such as keyboard 204. The front-end application program running on the computer then can correlate scanned product identifiers, such as barcodes or QR codes, with entries within the inventory/product database. Such entries may include a text description of the product, the ordinary price of the product, information as to whether the product is taxable, etc. Additional fields may be added to the database to make it seamlessly operate with an embodiment of the present invention. This additional field may identify customers who have made an offer for a discounted price that has been accepted, and the terms of the offer (generally the price). This allows the front-end POS system to automatically apply the terms of the agreed-upon offer to the transaction at checkout.

The front-end POS system may be electronically linked to a backroom server at the brick-and-mortar retailer. The backroom server contains the management and control software that collects transaction information from the networked POS systems, processes the collected information, and carries out management and maintenance tasks for the brick-and-mortar retailer. This may include, for example, inventory control, and accounting.

More recently, certain brick-and-mortar retailers have begun to offer self-checkout lines, where customers utilize simplified version of the front-end POS system to check out with little or no help from staff. The present invention could similarly be applied to such a system.

In both systems, however, it may be necessary to obtain some level of customer identification to match up the accepted offer with the particular customer checking out. In one embodiment of the present invention, the customer utilizes the application running on the mobile device to identify him or herself to the system. For example, the application may be designed to display a barcode uniquely identifying the user on the mobile device. The user may then cause this barcode to be scanned (either by the cashier or by him or herself in the case of self-checkout) to identify him or herself to the system. The unique customer identification can then be correlated to the accepted offer, which would also contain a unique customer identification. Alternatively, a driver's license or credit card may be swiped via a terminal and custom identification information read off the magnetic stripe contained in the driver's license or credit card.

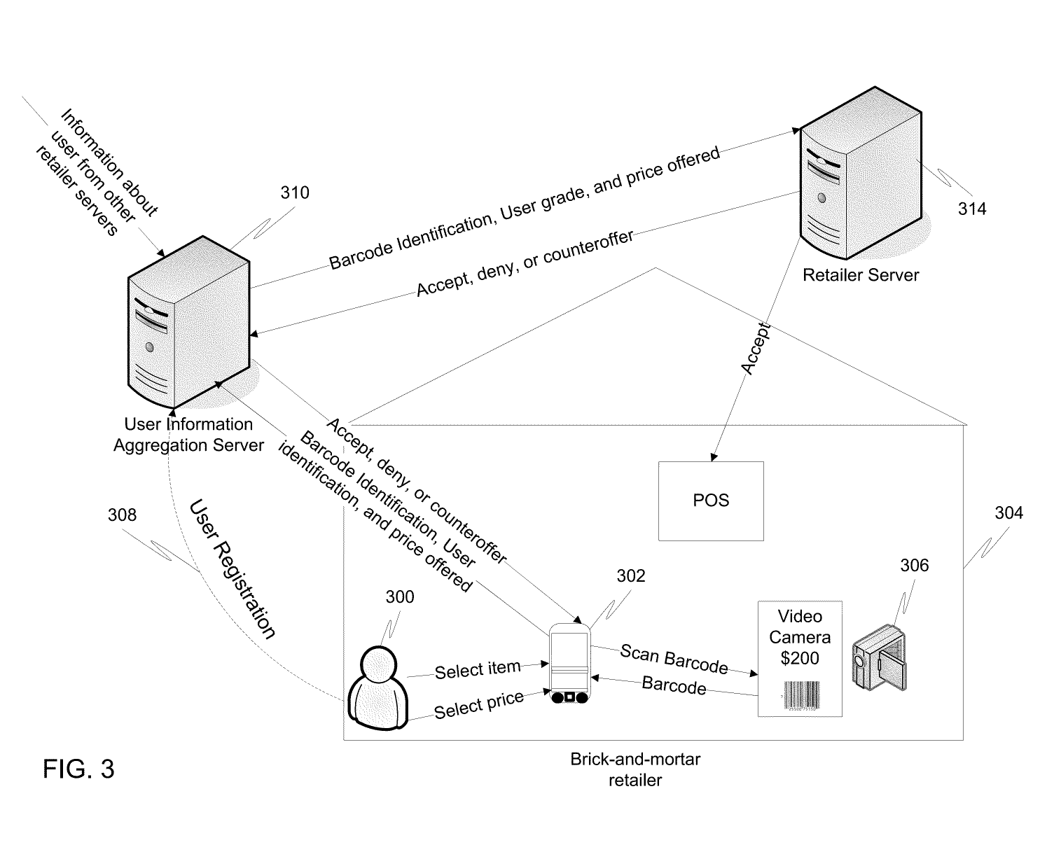

FIG. 3 is a diagram illustrating a system for electronic negotiation in a brick-and-mortar retailer in accordance with another embodiment of the present invention. Similarly to FIG. 1, user 300 operates a smartphone 302 while in brick-and-mortar retailer 304. Specifically, the user is viewing product 306 and enters information about the product in the smartphone to identify the product. This may involve scanning a barcode or QR code using a scanning program and camera built into the smartphone. Alternatively, the user could enter the product information using keypad input.

Here the user performs registration 308 with the user information aggregation server 310. This may be performed by signing up directly with the user information aggregation server 310, or doing so through the downloaded application on the mobile device. In one embodiment, the registration is performed prior to downloading the application and as a necessary step before downloading is permitted. In another embodiment, the registration is performed upon opening the application the first time. Registration allows the user information aggregation server to track information about the user. This may include past purchase information, demographic information, and user interests. The demographic information and user interests can be obtained via the registration process itself. The user information aggregation server 310 may gather information about the user's past purchases not just from retailer server 312 associated with this particular brick-and-mortar retailer, but also from other retailer servers associated with other brick-and-mortar or online retailers. In this manner, the user information aggregation server 310 may compute a grade that is based not just on the user's past history with this particular retailer, but also the user's past history with other retailers. This can be valuable information in putting together a more complete picture of the user's value to the retailer. This is especially true when the user may be visiting the brick-and-mortar retailer for the first time, and thus has no past purchase information with this particular brick-and-mortar retailer.

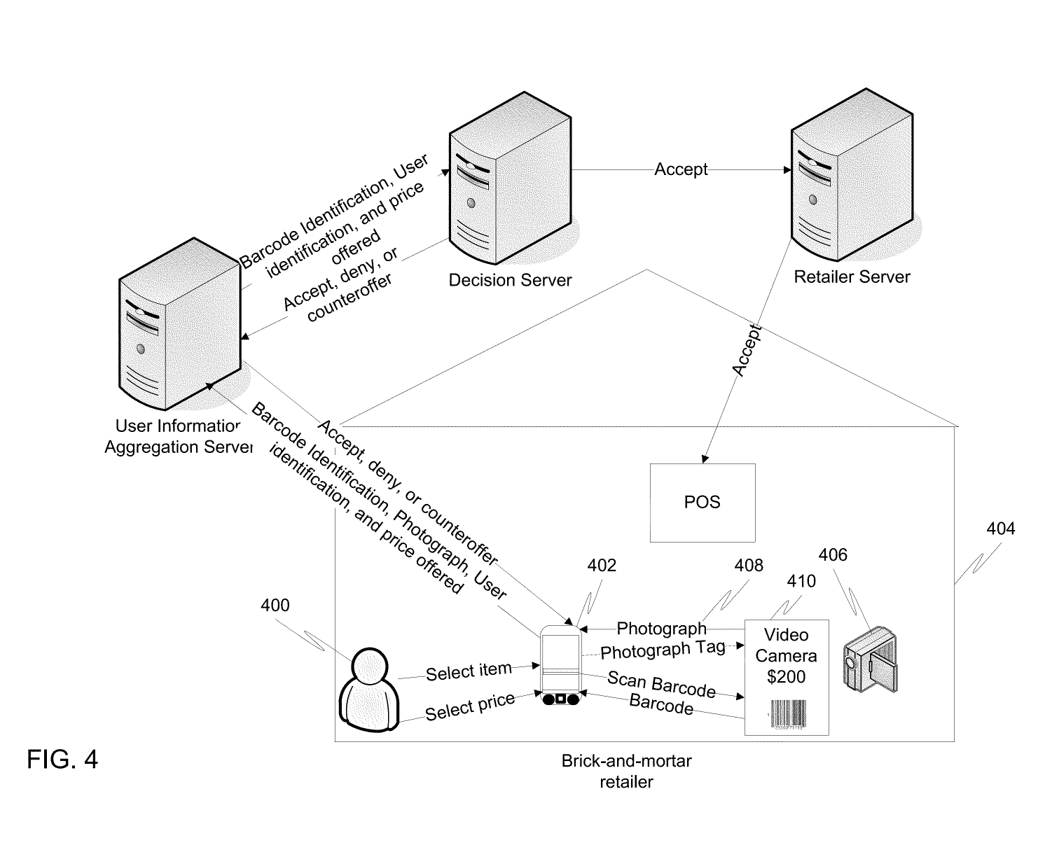

FIG. 4 is a diagram illustrating a system for electronic negotiation in a brick-and-mortar retailer in accordance with another embodiment of the present invention. Similarly to FIG. 1, user 400 operates a smartphone 402 while in brick-and-mortar retailer 404. Specifically, the user is viewing product 406 and enters information about the product in the smartphone 402 to identify the product. This may involve scanning a barcode or QR code using a scanning program and camera built into the smartphone. Alternatively, the user could enter the product information using keypad input. Regardless of the input method, this embodiment depicts augmenting the original input method with a photograph 408, here a photograph of the tag 410 itself (although in some embodiments a photograph of the product itself may be used). Through image recognition software, a unique identification of the product can be obtained via the photograph, or via a combination of the photograph and original input method (e.g., barcode scan). This may be valuable in situations where the original input method is not completely reliable, as is the case typically with barcodes.

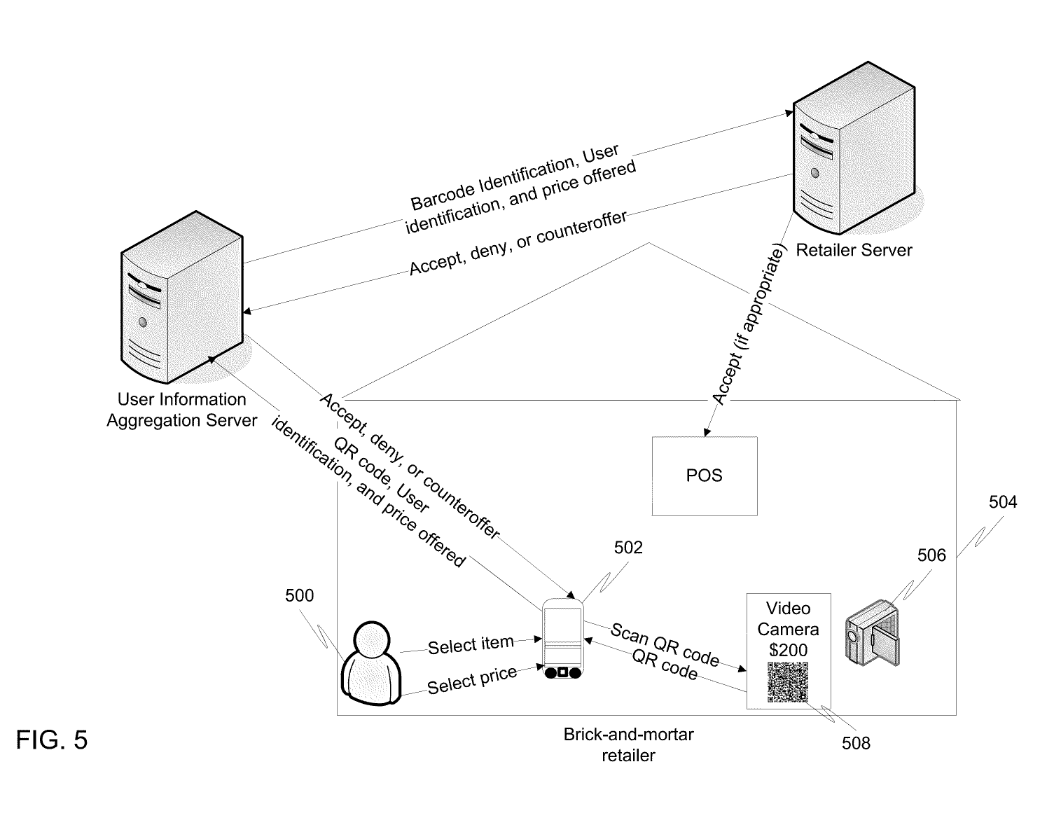

FIG. 5 is a diagram illustrating a system for electronic negotiation in a brick-and-mortar retailer in accordance with another embodiment of the present invention. Similarly to FIG. 1, user 500 operates a smartphone 502 while in brick-and-mortar retailer 504. Specifically, the user is viewing product 506 and enters information about the product in the smartphone to identify the product. Here, rather than a barcode scan, a QR scan 508 is depicted.

In another embodiment of the present invention, the price of a given product given to users at large can vary dynamically based upon offers to purchase received from other users. For example, if a number of customers in a store offer to purchase a product for a $10 discount, the retailer may elect to temporarily drop the price of the item by $10 for all customers in the store. This may be implemented in a number of different ways. In one example, an announcement may be made over a loudspeaker in the store alerting users to the drop in price. In another embodiment, price tags for products may be electronic (e.g., LCD screens showing a price). The electronic price tag may then be dynamically altered to change the price of the item. Indeed, it may even be possible that the price of the item can change while a particular customer is in the store, causing excitement in the customer to purchase the item “while the price lasts”. It is a relatively well known sales phenomenon that limited-time sales on items draw in a higher percentage of customers than a permanent markdown because the limited nature of the sale makes customers feel that they have to “act now” or risk losing out on the price drop. This embodiment of the present invention can take limited-time sales to a whole different level, where the time frame for the sale can be measured in minutes rather than days or weeks.

In another embodiment of the present invention, the system can operate in either an “active” mode or a “passive” mode. In active mode, the user presents prices to the retailer via the user information aggregation server in one or more offers to purchase, and the retailer then can accept, deny, or counter the offer as described above. In a passive mode, the system simply monitors for price drops that fall within the criteria of the user. For example, the user may indicate that if the price drops 10% or more they would like to purchase. If the retailer then drops the price, the user information aggregation server may, through updates, become aware of the price change and then alert the customer that the product is now available for the requested discount. This may be useful for situations where electronic negotiation is not possible (such as where the user does not have a smartphone) or where electronic negotiation is not wanted by either the customer (e.g., he or she is not ready to commit to purchase the item) or the retailer (e.g., the retailer is legally obligated to keep the price at a certain level for a certain period of time).

In another embodiment of the present invention, steps may be undertaken to help prevent false offers from being made. A false offer is one that is placed by the user that the user is unwilling to go through with should it be accepted. There may be any number of reasons why a false offer is made, from innocent (e.g., the user simply changes their mind about the product after the offer is made, the user was just “feeling out” the retailer, etc.) to more nefarious (e.g., the user is attempting to use his or her own good “grade” to lower the price for everyone, the user is attempting to determine the lowest possible price a retailer will accept by submitting shill bids from a number of different accounts, etc.). One mechanism that could potentially be used to reduce false offers is to ensure that an offer, once made, must be followed through by the user if the retailer accepts the offer. For example, a credit card may be kept on file and automatically charged if the offer is accepted and the user fails to follow through with the transaction following the acceptance. In another example, the user's “grade” may be penalized for false offers. In another example, a reputation score separate from the grade may be maintained and the reputation score may be reduced for every false offer made, with a threshold set at which the user's account is disabled.

In an embodiment of the present invention, a specialized application, or “app” may be installed on the user's smartphone or other mobile device that acts as the user agent to gather product information, obtain bid information from the user, send the bid information and product information (as well as user information) to the user information aggregation server, and ultimately receive and report the decision on the offer. This app may be available through an “app store”, via which the user may download the app and install it on his or her mobile device. The app may provide a user interface for the user to select various tasks. The app may also interface with one or more hardware components of the smartphone or other mobile device to obtain information about the product on which the offer is to be placed. As described above, this might involve using a camera embedded in the mobile device to scan a barcode or QR code, or take a picture. The obtained information may then be communicated to the user information aggregation server via a wireless networking protocol. This may include cellular phone data networks such as EDGE, 3G, 4G, LTE, and others, as well as other data networks such as WiFi, and WiMax. In one embodiment of the present invention, the app may be integrated directly into the wireless carrier's system, enabling communication between the app and the user information aggregation server via ordinary cellular communications (GSM, CDMA, AMPS, or via SMS text messages).

In the above-described embodiments, the offer negotiation is essentially bilateral, between the customer and the retailer, using the user information aggregation server as a facilitator. Embodiments are also possible where multi-lateral negotiations are utilized. For example, a retailer may be unwilling to discount the product by the amount requested by the customer, but may be willing to discount it part of the way with another retailer providing an additional discount in exchange for making a purchase with the other retailer as well. The user information aggregation server may act as a facilitator of these multi-lateral negotiations as well.

The multi-lateral negotiations can also extend to the customer-side as well. More specifically, a negotiation may ensue with multiple customers negotiating together with a single retailer. These customer can either being doing so knowingly, or may be unaware of each other's participation in the negotiation. In one example, a retailer may be willing to drop the price for a group of customers based on their combined bids and grades.

An even more complex case is foreseen where multiple customers are negotiating with multiple retailers. The user information aggregation server can facilitate all of these types of negotiations. Indeed, the user information aggregation server can facilitate multiple different types of negotiations simultaneously.

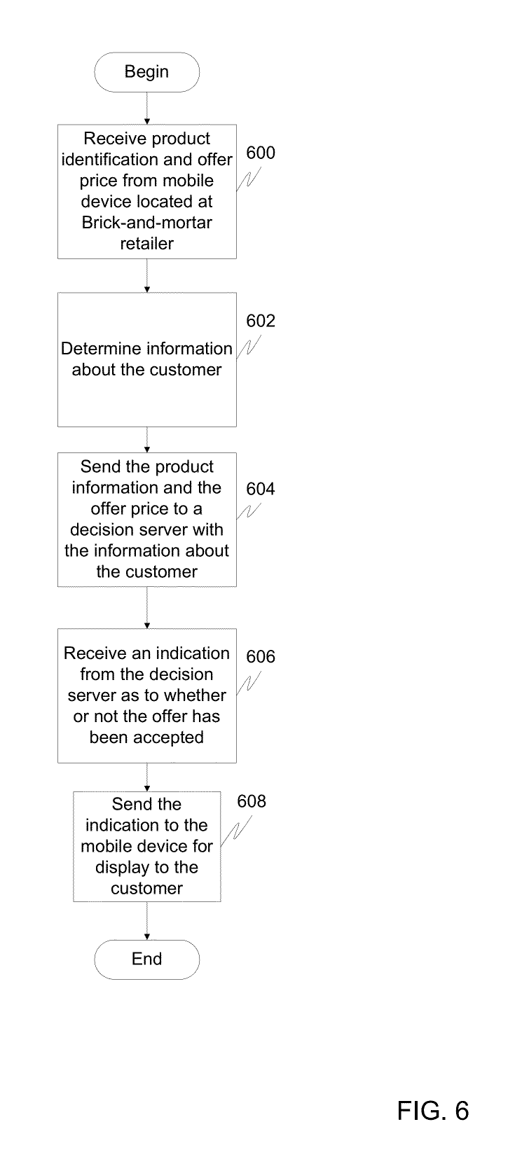

FIG. 6 is a flow diagram illustrating a method for enabling a retail transaction between a brick-and-mortar retailer and a customer in accordance with an embodiment of the present invention. At 600, a product identification and an offer price are received from a mobile device operated by the customer while located at the brick-and-mortar retailer. At 602, information may be determined about the customer. This may include simply receiving customer information from the mobile device and/or other sources, or actively seeking out information about the customer based upon customer identification information. At 604, the product information and the offer price are sent to a retailer server along with the information about the customer. At 606, an indication is received from the retailer server as to whether or not the offer has been accepted, wherein the retailer server bases the decision at least partially on the information about the customer. At 608, the indication is sent to the mobile device for display to the customer.

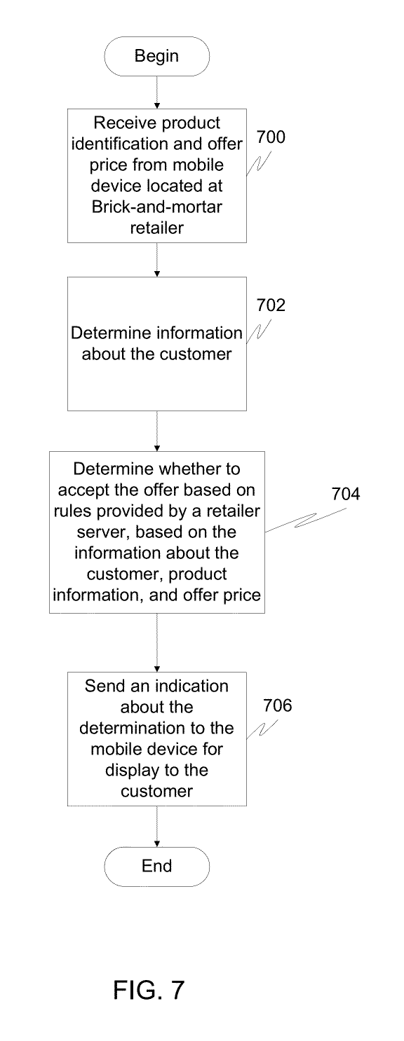

FIG. 7 is a flow diagram illustrating a method for enabling a retail transaction between a brick-and-mortar retailer and a customer in accordance with another embodiment of the present invention. At 700, a product identification and an offer price are received from a mobile device operated by the customer while located at the brick-and-mortar retailer. At 702, information may be determined about the customer. At 704, a determination is made as to whether to accept the offer based on rules provided by a retailer server, wherein the determination is based on a combination of the information about the customer, the product information, and the offer price. At 706, an indication about the determination is sent to the mobile device for display to the customer and to the brick-and-mortar retailer.

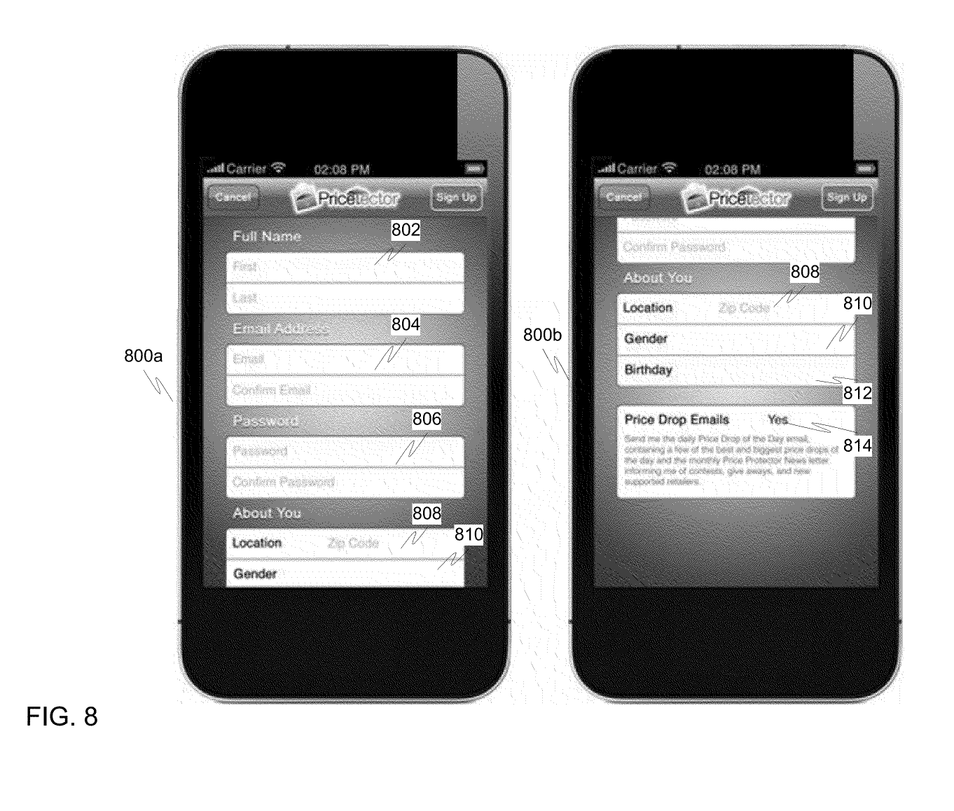

FIG. 8 is a screen capture depicting a registration screen in accordance with an embodiment of the present invention. The screen is depicted in two parts 800a, 800b, due to the length of the information presented. The user may scroll up or down to see the information in 800a and 800b, respectively. As can be seen, there are fields presented for the user to enter his or her name 802, email address 804, and a password 806. There are also fields where the user can enter more detailed personal information, such as location 808, gender 810, and birthday 812. This is, of course, merely an example of the types of information that can be provided during registration. There is also a field 814 where the user may select to receive price drop emails. A price drop email is a daily email indicating the largest price drops available from partner retailers. This email could also be used to communicate deals that are offered based on other customers' offers for product. For example, if enough people bid for a $10 discount on a particular product, the retailer may elect to send out the same deal to select other (valued) customers that weren't even bidding on the product. The price drop email may be utilized to convey this information.

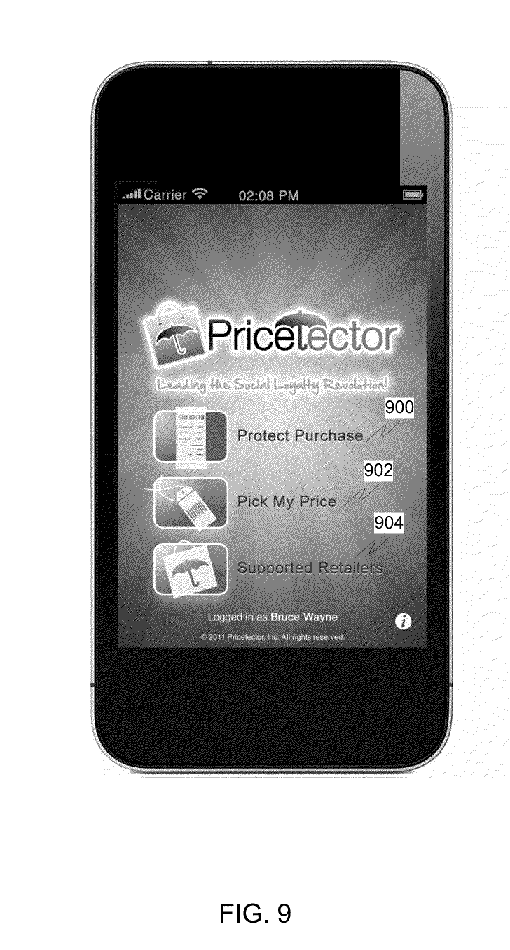

FIG. 9 is a screen capture depicting a main menu screen in accordance with an embodiment of the present invention. Here, the user is able to select from various modules, including a protect purchase module 900, a pick my price module 902, and a supported retailers module 904. The supported retailers module 904 allows the user to view a list of retailers supported by the system. The protect purchase module 900 allows the user to register a purchase for price protection. This module is beyond the scope of the present document. Most relevant for the present invention is the pick my price module 904.

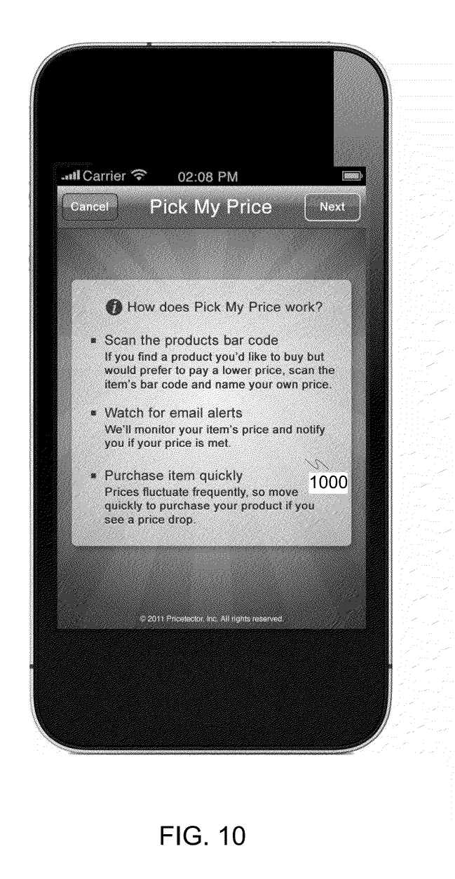

FIG. 10 is a screen capture depicting a pick my price screen in accordance with an embodiment of the present invention. Here, the user has selected the pick my price module, and is first presented with a brief description 1000 of how the module works. As is described on the screen, the user scans the products using a barcode, and then enters a price. The user is then registered for email alerts involving the decision as to the offer.

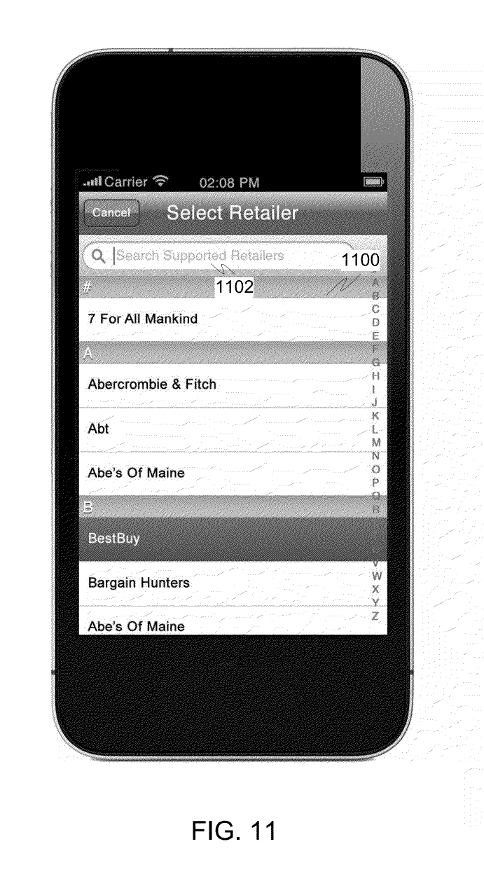

FIG. 11 is a screen capture depicting a selection of retailer screen in a pick my price module in accordance with an embodiment of the present invention. A list of retailers participating in the program is provided at 1100, and the user may either scroll through the list or utilize a search field 1102. The user may then select the retailer he or she is currently located in. It should be noted that while in this embodiment the user manually enters the retailer information, other embodiments are possible where this information is gathered automatically. For example, the mobile device may be able to detect which store it is currently located in using GPS or other location-tracking elements. Alternatively, the next step, where a barcode or other product identification is obtained may also inform the system as to the location of the user (e.g., if the barcode contains a unique identifier for the retailer as well as identifying the product).

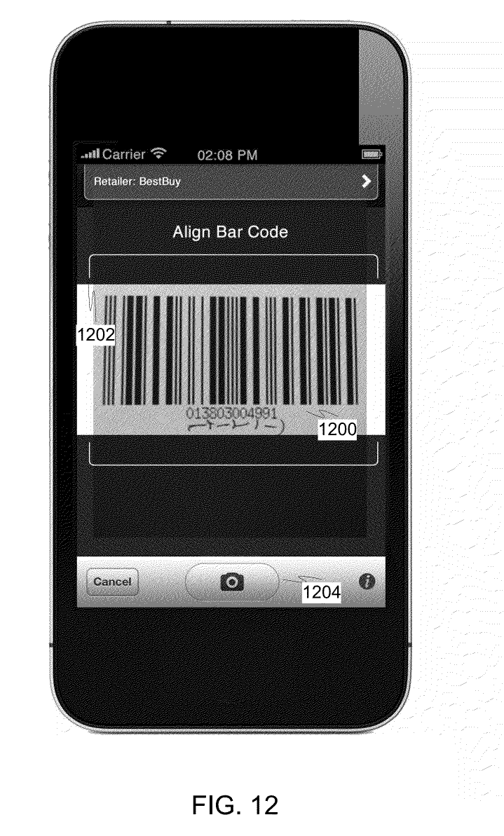

FIG. 12 is a screen capture depicting the scanning of a barcode in accordance with an embodiment of the present invention. Here, the user utilizes a camera on the mobile device and aligns the barcode 1200 with a box 1202 on the screen. The user can then press a “capture” button 1204 to capture the barcode. Alternatively, the system may automatically capture the barcode when the barcode 1200 is aligned with the box 1202.

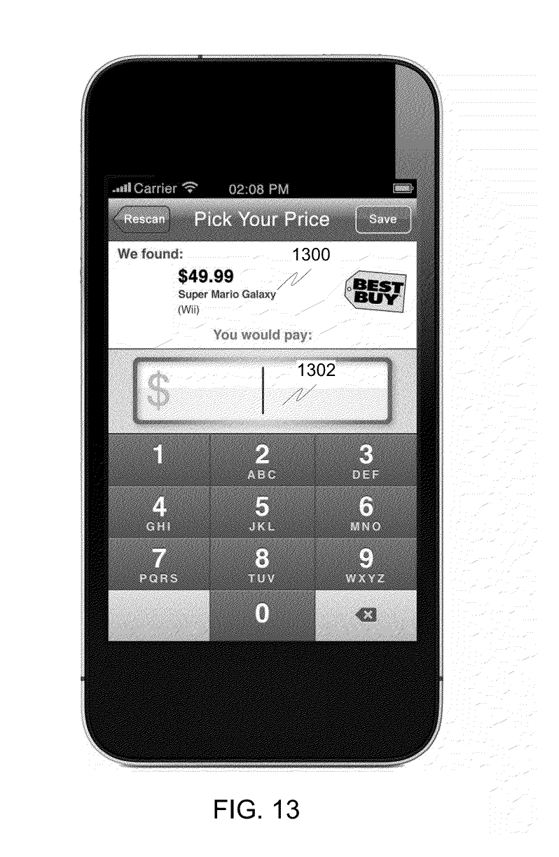

FIG. 13 is a screen capture depicting the entering of an offer in accordance with an embodiment of the present invention. Here, the user has selected “Best Buy” in the retailer field (FIG. 11) and scanned a barcode for a video game with a retail price of $49.95. Information about the identified product, including the title, photograph, and retailer price may be presented at 1300 so that the user knows he or she is bidding on the correct product. The user may then enter a price he or she wishes to pay in field 1302.

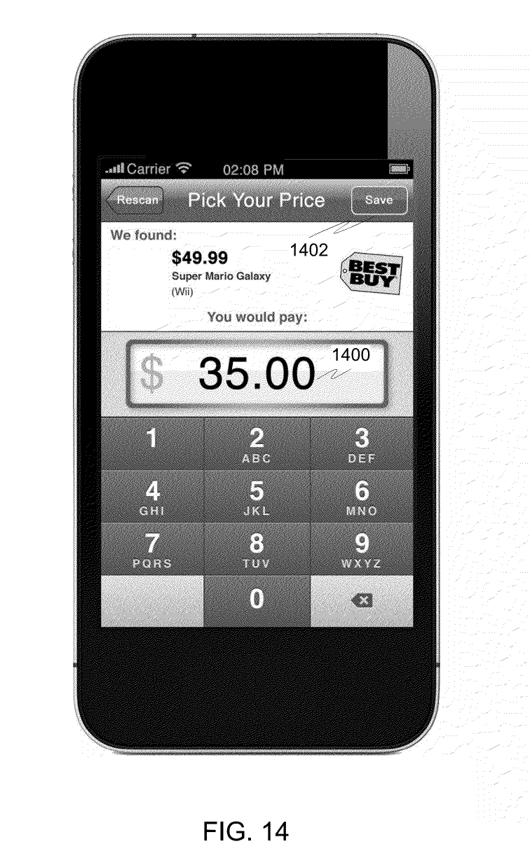

FIG. 14 is a screen capture depicting an entered offer in accordance with an embodiment of the present invention. Here, the user has entered at 1400 a desired price of $35.00. The user may then select a save button 1402.

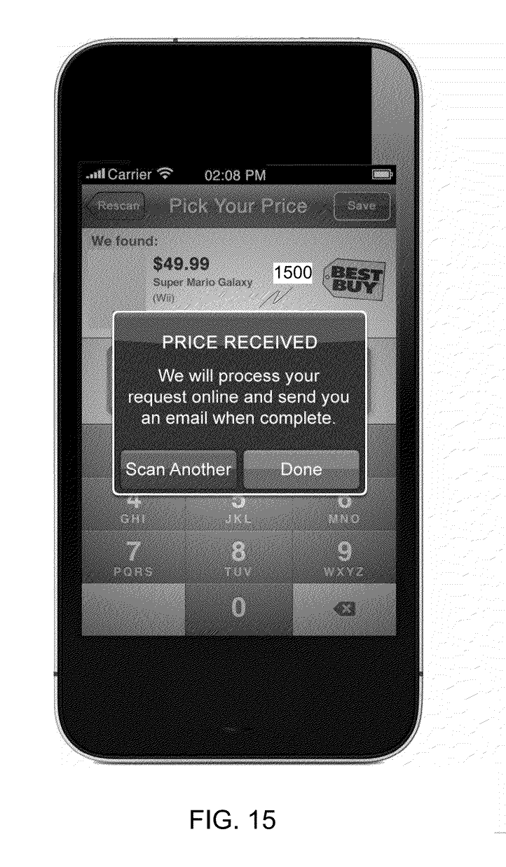

FIG. 15 is a screen capture depicting confirmation of a received offer in accordance with an embodiment of the present invention. Here, the user receives an indication 1500 that an email will be forthcoming with a decision. Of course, delivery of the decision via email is merely one example of how the decision can be made available to the user. In another example, the program itself provides a pop-up window with the decision immediately upon receipt.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A system for enabling a retail transaction between a brick-and-mortar retailer and a customer, the system comprising:
a mobile device, wherein the mobile device includes an application operated by the customer while physically present in the brick-and-mortar retailer, wherein the application is designed to obtain product information about a product and offer information from the customer including a proposed price for the product;
a user information aggregation server designed to receive the product information and the offer information from the application on the mobile device and augment the product information and offer information with information about the customer, and to forward the product information, offer information, and customer information to a decision server; and
wherein the user information aggregation server is further designed to receive a decision as to whether the offer has been accepted by the decision server, wherein the decision is at least partially based on the customer information, and to notify the customer of the decision.

2. The system of claim 1, wherein the retailer server is designed to facilitate a transaction based on the offer if the offer is accepted by the decision server.

3. The system of claim 1, wherein the user information aggregation server is further designed to assign a grade to the customer based on the customer information.

4. The system of claim 1, wherein the retailer server is designed to execute rules to automatically determine whether to accept the offer based at least partially on the customer information.

5. The system of claim 1, wherein communication between the mobile device and the user information aggregation server is conducted via a wireless data network.

6. A method for enabling a retail transaction between a brick-and-mortar retailer and a customer, the method comprising:
receiving a product identification and an offer price from a mobile device operated by the customer while located at the brick-and-mortar retailer;
determining information about the customer;
sending the product information and the offer price to a decision server along with the information about the customer;
receiving an indication from the decision server as to whether or not the offer has been accepted, wherein the retailer server bases the decision at least partially on the information about the customer; and
sending the indication to the mobile device for display to the customer.

7. The method of claim 6, wherein the product identification includes a barcode scanned from a product or tag associated with the client.

8. The method of claim 6, further comprising sending information regarding an accepted offer to the brick-and-mortar retailer.

9. The method of claim 8, wherein the sending information regarding an accepted offer includes sending the information regarding the accepted offer to an point-of-sale system operated by the brick-and-mortar retailer.

10. The method of claim 6, wherein the information about the customer includes a grade applied to the customer based on his or her value as a customer to the brick-and-mortar retailer.

11. The method of claim 6, wherein the information about the customer includes purchase history of the customer.

12. The method of claim 6, wherein the information about the customer includes demographic information about the customer.

13. The method of claim 6, wherein the information about the customer includes customer interests.

14. A non-transitory program storage device readable by a machine tangibly embodying a program of instructions executable by the machine to perform a method for enabling a retail transaction between a brick-and-mortar retailer and a customer, the method comprising:
receiving a product identification and an offer price from a mobile device operated by the customer while located at the brick-and-mortar retailer;
determining information about the customer;
making a determination of whether to accept the offer based on rules provided by a retailer server, wherein the determination is based on a combination of the information about the customer, the product information, and the offer price; and
sending an indication about the determination to the customer and to the brick-and-mortar retailer.

15. The non-transitory program storage device of claim 14, wherein the determination is additionally based upon offer information received from other customers via other mobile devices.

16. The non-transitory program storage device of claim 14, wherein the determination is made without further retailer server involvement if a discount requested via the offer information is less than a specified threshold.

17. The non-transitory program storage device of claim 14, wherein the method further includes causing a transaction between the customer and the brick-and-mortar retailer for the product to be completed if the determination is to accept the offer.

18. An apparatus for enabling a retail transaction between a brick-and-mortar retailer and a customer, the apparatus comprising:
means for receiving a product identification and an offer price from a mobile device operated by the customer while located at the brick-and-mortar retailer;
means for determining information about the customer;
means for sending the product information and the offer price to a decision server along with the information about the customer;
means for receiving an indication from the retailer server as to whether or not the offer has been accepted, wherein the decision server bases the decision at least partially on the information about the customer; and
means for sending the indication to the mobile device for display to the customer.

19. The apparatus of claim 18, further comprising means for maintaining a grade for the customer based on a combination of past purchase information, demographic information, and customer interest information.

20. The apparatus of claim 18, wherein the means for maintaining a grade includes means for reducing the grade assigned to the customer if the offer is accepted but the customer does not complete a transaction for the product at the accepted offer price.
